(19) United States
(12) Patent Application Publication
(10) Pub. No.: US 2002/0080148 A1
(43) Pub. Date: Jun. 27, 2002

(54) Image processing device and image processing method

(76) Inventor: Fumiko Uchino, Otokuni-Gun (JP)

Correspondence Address: Platon N. Mandros, BURNS, DOANE, SWECKER & MATHIS, L.L.P., P.O. Box 1404, Alexandria, VA, 22314-1404, US

(21) Appl. No.: 09/983,678

(22) Filed: Oct. 25, 2001

(30) Foreign Application Priority Data
Nov. 9, 2000 (JP) 2000-342078

(51) Int. Cl. H04N 13/00; H04N 15/00

(52) U.S. Cl. 345/629; 348/42; 382/154

(57) ABSTRACT

Data of a three-dimensional model and data of a two-dimensional image (object color component data) are combined and managed as a single file so as to paste a two-dimensional image (object color component image) excluding the influence of illumination light on the surface of a three-dimensional model. As a result, the illumination environment of the three-dimensional model can be easily modified by the illumination data in this file (object color component data).

### RELATED APPLICATION

This application is based on Patent Application No. 2000-342078 filed in Japan, the entire content of which is hereby incorporated by reference.

### BACKGROUND OF THE INVENTION

1. Field of the Invention

The present invention relates to art for combining two-dimensional image data and three-dimensional model data.

2. Descirption of the Related Art

Conventionally, in the field of three-dimensional graphics, a computer-generated three-dimensional model (i.e., a model expressed by data in three-dimensional directions to represent a so-called solid shape; when displayed on a flat display device as an image, the image cannot be distinguished from a two-dimensional image although the depth direction data are actually present; accordingly, it is possible to generate a silhouette at the model surface based on a light source by rotating the image) is combined with a two-dimensional image acquired by photography. Executing a process to reflect influence of a light source and affix color to a three-dimensional model (changing color tint, shading and the like), and combining a two-dimensional image of a landscape or the like to the obtained three-dimensional model as a background is an example of such a process.

Another example is image base rendering wherein a two-dimensional image is pasted on the surface of a three-dimensional mode. A more realistic three-dimensional computer model can be generated by image base rendering.

When combining a two-dimensional image acquired by photography as a background image with a three-dimensional model generated by computer, a process for combining the ambience of both the image and the model is required. At this time, color tint correction may be performed on the two-dimensional image, and illumination light correction may be performed on the three-dimensional mode. However, the ambience of both the image and model cannot be easily combined by adjusting RGB values and CMY values, such that the adjustment operation requires a specialist with technical expertise.

On the other hand, when pasting a two-dimensional image on the surface of a three-dimensional model, it is difficult to change the ambience of the obtained three-dimensional model due to the inclusion of illumination environment influences during photography in the two-dimensional image. That is, when combining a three-dimensional model with another two-dimensional image, it is difficult to eliminate a feeling of incompatibility.

### SUMMARY OF THE INVENTION

An object of the present invention is to eliminate the previously described problems.

Another object of the present invention is to suitably combine a two-dimensional image and a three-dimensional model generated by computer.

Still another object of the present invention is to provide a method and device for easily modifying ambience by color tint combining a two-dimensional image and a three-dimensional model generated by computer.

These and other objects are attained by an image processing device having an acquisition unit for acquiring three-dimensional model data, an acquisition unit for acquiring object color component image data corresponding to an object-color component image obtained by removing illumination environment influences from a two-dimensional image, and a combining unit for combining three-dimensional model data and object color component image data so as to paste an object color component image on the surface of an image represented by three-dimensional model data.

These objects of the present invention are further attained by an image processing method having a step of acquiring three-dimensional model data, a step of acquiring two-dimensional image data, a step of calculating object color component image data corresponding to an object color component image from which illumination environment influences have been removed in a two-dimensional image based on the acquired two-dimensional image data, and a step of combining three-dimensional model data and object color component image data so as to paste an object color component image on the surface of an image represented by three-dimensional model data.

The invention itself, together with further objects and attendant advantages will be best understood by reference to the following detailed description taken in conjunction with the accompanying drawings.

### BRIEF DESCRIPTION OF THE DRAWINGS

FIG. 1 shows the structure generating object color component data;

FIG. 2 is a flow chart showing the process for calculating object color component data;

FIG. 3 is a flow chart showing the process for regenerating an image from object color component data;

FIG. 4 is a block diagram showing the structure of a third embodiment of an image processing device;

FIG. 5 is a block diagram showing the function structure of the image processing device;

FIG. 6 is a flow chart showing the operation of the image processing device;

FIG. 7 is a schematic view showing the condition of processing by the image processing device;

FIG. 8 is a front view of a first embodiment of an image acquisition device;

FIG. 9 is a block diagram showing the internal structure of the image acquisition device;

FIG. 10 is a block diagram showing the function structure of the image acquisition device;

FIG. 11 is a flow chart showing the processing by the file generator;

FIG. 12 shows the structure of a three-dimensional object file;

FIG. 13 is a block diagram showing the function structure of a first embodiment of an image regenerating device;

FIG. 14 is a flow chart showing the operation of the image regenerating unit;

FIG. 15 shows an example of the display content when selecting illumination light;

FIG. 16 is a block diagram showing the function structure of a second embodiment of an image generating device;

FIG. 17 is a flow chart showing the operation of the image regenerating device; and

FIG. 18 is a schematic view showing the condition of regeneration of a three-dimensional model.

In the following description, like parts are designated by like reference numbers throughout the several drawings.

### DESCRIPTION OF THE PREFERRED EMBODIMENTS

<Object Color Component Image Acquisition Example>

Object color component image used to generate an image of an object under various illumination environments, and the method of acquiring such images are described below.

An object color component image is an image equivalent to components from which the influences of illumination environment on an object have been eliminated from the image, and is called an image in which data equivalent to spectral reflectance of an object affect the pixel. Object color component image data (hereinafter referred to as “object color component data”) may be acquired by various methods, and are described by way of examples below.

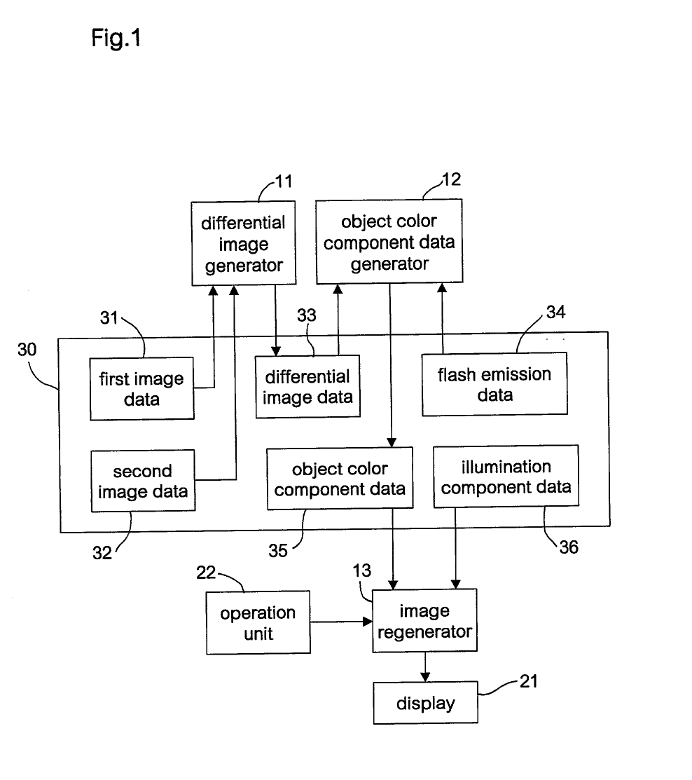

FIG. 1 shows a structure for generating object color component data based on a first image acquired by photography using flash illumination and a second image acquired without a flash, as well as other related structures. For example, functions can be realized as shown in FIG. 1 by a differential image generator 11, object color component data generator 12, and image regenerator 13 by the CPU of a computer executing calculation processing in accordance with programs.

All or part of these function structures may be realized by special electrical circuits, and a special device or digital camera or the like may have these function structures. The function structures referenced in the following description and shown in the block diagrams are identical.

The image regenerator 13 is connected to a display 21 for displaying an image generated based on object color component data 35, and an operation unit 22 for receiving input from a user. A memory 30 is provided beforehand with first image data 31, second image data 32, flash emission data 34, and illumination component data 36. The first image data 31 are equivalent to an image acquired by a digital camera using a flash emission, the second image data 32 are equivalent to an image acquired without a flash. The two photographs are taken in rapid succession as in consecutive photography, such that the photographic range of the first image and the second image are identical. The two photographs are taken using conditions of identical shutter speed (CCD accumulation time) and stop value.

The flash emission is controlled so as to provide uniform spectral distribution of the flash light. Specifically, the voltage of the flash power source and the emission time is uniformly regulated. The spectral distribution of the flash light is measured beforehand, and stored in a memory 30 as flash spectral data 34. Specifically, the relative spectral distribution of the flash light (i.e., a spectral distribution wherein the maximum spectral intensity is standardized at [1]; hereinafter referred to as “relative spectral distribution”) is designated as the flash spectral data 34.

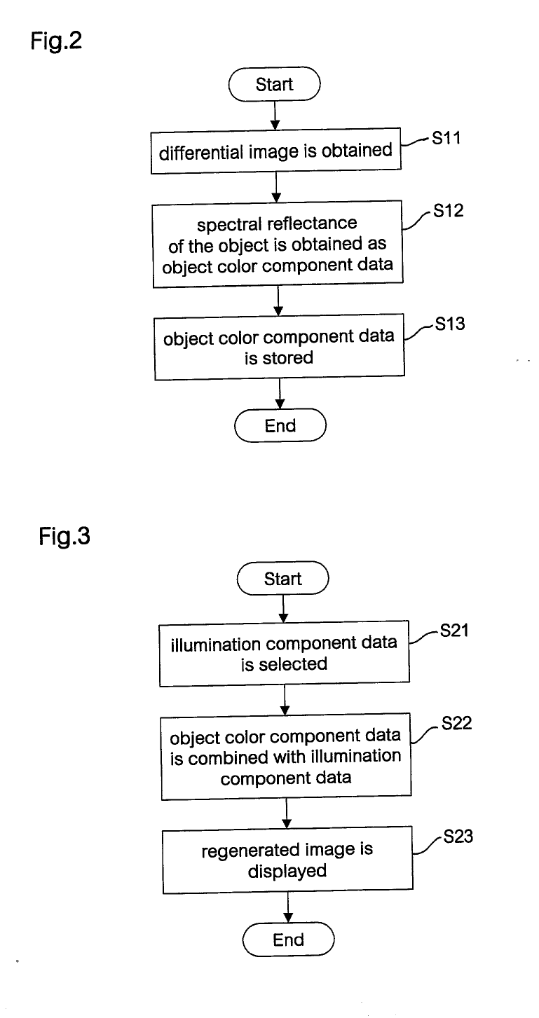

FIG. 2 shows the flow of the process for calculating the object color component data 35 from the first image data 31, second image data 32, and flash spectral data 34.

First, the differential image generator 11 subtracts the second image data 32 from the first image data 31 to determine the differential image data 33. That is, the R, G, and B values of pixels corresponding to the second image are subtracted from the R, G, and B values of each pixel of the first image to obtain a differential image of the first image and the second image (step S11).

Next, the object color component data generator 12 determines data (i.e., object color component data 35) of an object color component image equivalent to components excluding the influence of the illumination environment from an image using the differential image data 33 and the flash emission data 34 (step S12). The object color component data 35 is roughly equivalent to the spectral reflectance of the object as previously described. The principle of determining the spectral reflectance of an object is described below.

When the spectral distribution of the illumination light illuminating an object (i.e., the light directly from a light source and indirect light included in the illumination environment is called the illumination light) is designated E(λ), and weighted coefficients ε1, ε2, ε3 and three base functions E1(λ), E2(λ), E3(λ) of the spectral distribution E(λ) are used, their relationship can be expressed below.

$$E ( λ ) = {\sum }_{i = 1}^{3} ϵ iEi ( λ ) \qquad ( Expression 1 )$$

Similarly, when the spectral reflectance at a position on an object corresponding to a specific pixel (hereinafter referred to as “target pixel”) is designated S(λ), and weighted coefficients σ1, σ2, σ3 and three base functions S1(λ), S2(λ), S3(λ) of the spectral distribution S(λ) are used, their relationship can be expressed below.

$$S ( λ ) = {\sum }_{j = 1}^{3} σ jSj ( λ ) \qquad ( Expression 2 )$$

Then, light I(λ) entering a target pixel on the CCD (i.e., incidence light when filters and the like anterior to the CCD are ignored) can be expressed by the equation below.

$$I ( λ ) = {\sum }_{i = 1}^{3} ϵ iEi ( λ ) \cdot {\sum }_{j = 1}^{3} σ jSj ( λ ) \qquad ( Expression 3 )$$

Furthermore, the value relating to any color R, G, B of the target pixel (hereinafter referred to as “target color”) is ρc, such that when the spectral sensitivity of the CCD to a target color is designated Rc(λ), the value ρc can be derived from the equation below.

ρ_{c}=∫R_{c}(λ)I(λ)dλ (Expression 4)

At this time, when the target color value of a first pixel when the flash is ON is designated ρc1, and the value corresponding to a second pixel when the flash is OFF is designated ρc2, then a value ρB corresponding to a differential pixel can be expressed as stated below.

(Expression 5)

$$\begin{matrix}{ρ}_{s} = {ρ}_{c1} - {ρ}_{c2} \\ = \int Rc ( λ ) \{ {I}_{1} ( λ ) - {I}_{2} ( λ ) \} ⅆ λ \\ = \int Rc ( λ ) \{ {\sum }_{i = 1}^{3} ( {ϵ}_{1} i - {ϵ}_{2} i ) Ei ( λ ) \cdot {\sum }_{j = 1}^{3} σ jSj ( λ ) \} ⅆ λ \\ = {\sum }_{i = 1}^{3} {\sum }_{j = 1}^{3} {ϵ}_{s} iσ j \{ \int Rc ( λ ) Ei ( λ ) Sj ( λ ) ⅆ λ \}\end{matrix}$$

I1(λ) is the light entering the target pixel when the flash is ON, and ε11, ε12, ε13 are weighted coefficients of the base function relating to illumination light including the flash light. Similarly, I2(λ) is the light entering a target pixel when the flash is OFF, and ε21, ε22, ε23 are weighted coefficients of the base function relating to illumination light excluding flash light. εsi (i=1, 2, 3) is (ε1i-ε2i).

In equation 5, the base functions Ei(λ) and Sj(λ) are functions determined beforehand, and the spectral sensitivity Rc(λ) is a function which can be determined by measurement beforehand. This information is stored in the memory 30 beforehand. On the other hand, a differential image derived by subtracting a second image from a first image is equivalent to an image influenced only by a change in the illumination environment, i.e., an image in which only the flash light is used as an illumination light source by similarly controlling the shutter speed (or CCD accumulation time) and stop value for two photographs. Accordingly, the weighted coefficient εsi can be derived from the relative spectral distribution of the flash light via a method described later.

In the equations of equation 5, the three weighted coefficients σ1, σ2, σ3 are the only unknowns. The equations of equation 5 can be determined relative to the three colors R, G, B of a target pixel, and the three weighted coefficients σ1, σ2, σ3 can be determined by solving these three equations. That is, it is possible to obtain the spectral reflectance at a position on an object corresponding to a target pixel.

The method for determining the weighted coefficient εsi is described below. The differential image as previously described is equivalent to an image illuminated only by the flash light, and the relative spectral distribution of the illumination light in the differential image is already known. However, a region on an object distant from the flash receives less flash light than a region near the flash. Accordingly, in a differential image, a position distant from the flash normally appears darker.

While maintaining fixed relative relationships among the three weighted coefficients εg1, εg2, εg3m, the values of these weighted coefficients are increased or decreased in proportion to the luminance of the target pixel (or region having the target pixel at the center) in the differential image. Specifically, when the target pixel in the differential image has a small luminance, the value of the weighted coefficients εs1, εs2, εs3 are set as small values, and when the luminance is large, the values of the weighted coefficients εs1, εs2, εs3 are set as large values. The relative relationships among the three weighted coefficients εs1, εs2, εs3 are determined beforehand such that the weighted sum of the three base functions E1(λ), E2(λ), and E3(λ) are proportional to the spectral distribution of the flash light, and the proportional relationship of luminance and εsi is determined by measurement beforehand.

The weighted coefficient εsi is a value representing the spectral distribution of the flash light illuminating a position on an object corresponding to the target pixel, and is a value representing the spectral distribution of the amount of change of illumination light of the flash between the first image and the second image. Accordingly, the process for determining the weighted coefficient εsi by the flash emission data 34 is equivalent to a process for determining the amount of spectral change in the illumination environment (illumination light) by the flash from the relative spectral distribution of the flash light.

The spectral reflectance (weighted coefficients σ1, σ2, σ3) on an object corresponding to each pixel is determined while referencing the pixel value of the differential image data 33 and flash emission data 34 based on the previously described principle. The object spectral reflectance is equivalent to image data from which the influence of the illumination environment has been removed, and is stored in the memory 30 as object color component data 35 (step S13).

When the weighted coefficients σ1, σ2, σ3 are determined, it is also possible to determine the spectral distribution of the illumination light during photography. That is, three equations are determined relating to the weighted coefficients ε21, ε22, ε23 based on the R, G, B value of each pixel of the second image by the equations 3 and 4, and the weighted coefficient ε2i relating to each pixel in the second image is determined by solving these equations. The weighted coefficient ε2i determined for each pixel becomes the component representing the influence of the illumination environment excluding the flash light.

In general, when the illumination environment has uniform illumination light, there is little dispersion of the weighted coefficient ε2i of each pixel. The average value of the weighted coefficients ε21, ε22, ε23 can be determined for all pixels, and the three determined weighted coefficients εi and the base function εi(λ) can be used as data representing the spectral distribution of the illumination light.

The basic method of using the object color component data 35 is described below. FIG. 3 shows the flow of processing when an image is regenerated from the object color component data 35. First, various types of illumination light are selected to be combined with the object color component data 35 through the operation unit 22 (step S21), and the illumination component data 36 corresponding to the selected illumination light are input to the image regenerator 13 from the memory 30. The object color component data 35 are also input to the image regenerator 13.

The illumination component data 36 are in a form which represents the spectral distribution of the illumination light by the weighted coefficient εi and based function Ei(X) shown in equation 1. Spectral distributions such as normal light (D65 and D50) beforehand, sunlight, fluorescent light and the like, and the spectral distribution of illumination light generated when generating the object color component data 35 are prepared as illumination component data 36.

Then, the image regenerator 13 combines the object color component data 35 and the selected illumination component data 36 (step S22). That is, the calculations shown in equations 3 and 4 are performed. In this way displayable image data are generated, and an image of the object determined by the object color component data 35 illuminated by the illumination light represented by the illumination component data 36 is regenerated on the display 21 (step S23).

As described above, the object color component data 35 become image data including the influence of the illumination environment represented by the illumination component data 36 by being combined with the illumination component data 36. Accordingly, it is possible to generate images of the same object including ambience of various illumination environments by using the object color component data 35.

<First Embodiment>

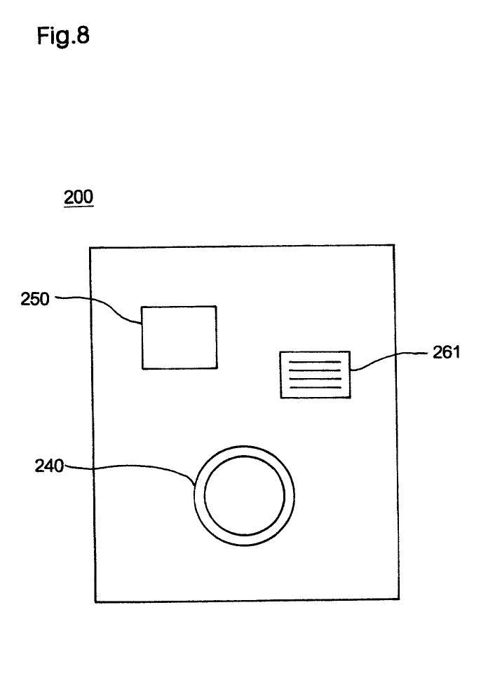

FIG. 8 is a front view a first embodiment of an image capture device 200. The front side of the image capture device 200 is provided with an image sensing unit 240 for acquiring a color two-dimensional image of an object, a scanning unit 250 for emitting laser light for acquiring a distance image (i.e., an image providing depth direction information) of an object using a light-section method, and a flash 261 for emitting flash light toward the object. On the back side of the image capture device 200 are arranged a display and operation buttons.

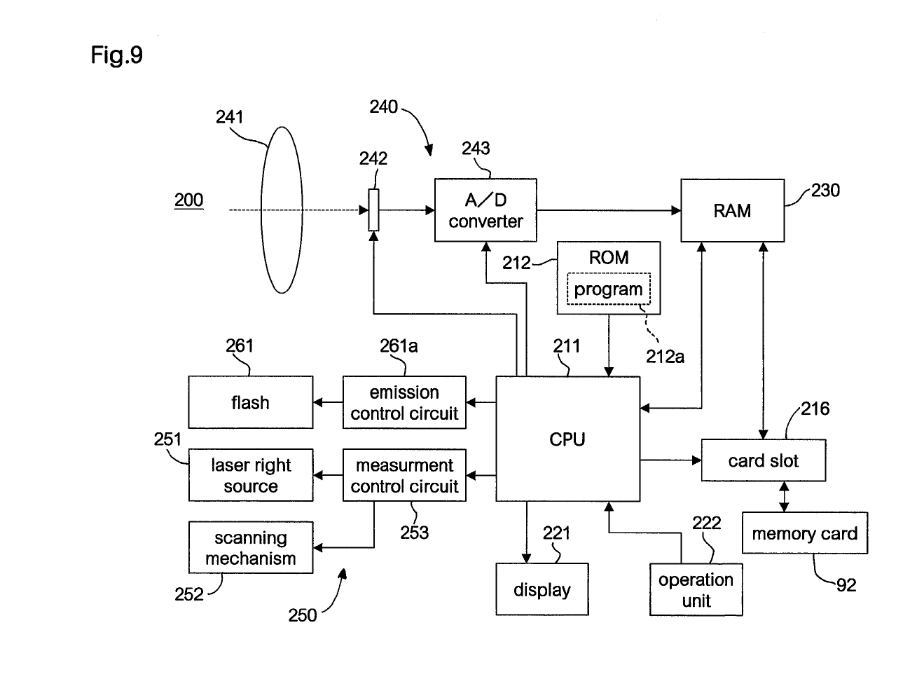

FIG. 9 is a block diagram showing the internal structure of the image capture device 200. The image sensing unit 240 is provided with a lens system 241 having a plurality of lenses, and a CCD 242 for acquiring the image of an object through the lens system 241. Image signals output from the CCD 242 are converted to digital image signals by an A/D converter 243, and are recorded in RAM 230. The CCD 242 is a 3-band image sensor for acquiring values relating to each R, G, B color as values of each pixel.

The scanning unit 250 is provided with a laser light source 251 for emitting laser light, a scanning mechanism 252 for scanning a laser beam on an object, and a measurement control circuit 253 for controlling the laser light source 251 and the scanning mechanism 252. While laser light is emitted, an image of an object (i.e., measurement target) is acquired by the image sensing unit 240, and a CPU 211 determines the shape of the surface of the object from the positional relationship of the image sensing unit 240 and the scanning unit 250, and the laser emission direction, and this shape is designated the distance image.

The flash 261 is connected to the CPU 211 through an emission control circuit 261a, such that when the flash 261 receives instruction to turn ON from the CPU 211, the emission control circuit 261a controls the emission so as to have no dispersion of emission characteristics of the flash 261 in each photograph. In this way, a uniform spectral distribution (spectral intensity) is maintained in the light from the flash 261.

Connected to the CPU 211 are a display 221 for displaying images and various types of information to an operator, and an operation unit 222 for receiving input from an operator. A card slot 216 transfers data between a RAM 230 and a memory card 92 under the control of the CPU 211. In this way, data can be transferred to/from other devices such as a computer or the like via the memory card 92.

A program 212a is recorded on the ROM 212, and acquisition of image data described later and processing of image data are realized by the CPU 211 operating in accordance with the program 212a. That is, the image capture device 200 partially has the structure of a computer.

When acquiring an image via the image capture device 200, the CPU 211 is operated in accordance with the program 211a to acquire first image data 31 and second image data 32 shown in FIG. 1. That is, a photograph is taken with the flash turned ON, and a first image is acquired by the image sensing unit 240, then a photograph is taken with the flash turned OFF, and a second image is acquired by the image sensor 240. At this time, the spectral distribution of the flash light is controlled to a specific distribution via control by the emission control circuit 261a. Then, the CPU 211 generates object color component data by functions similar to the differential image generator 11 and object color component data generator 12 shown in FIG. 1.

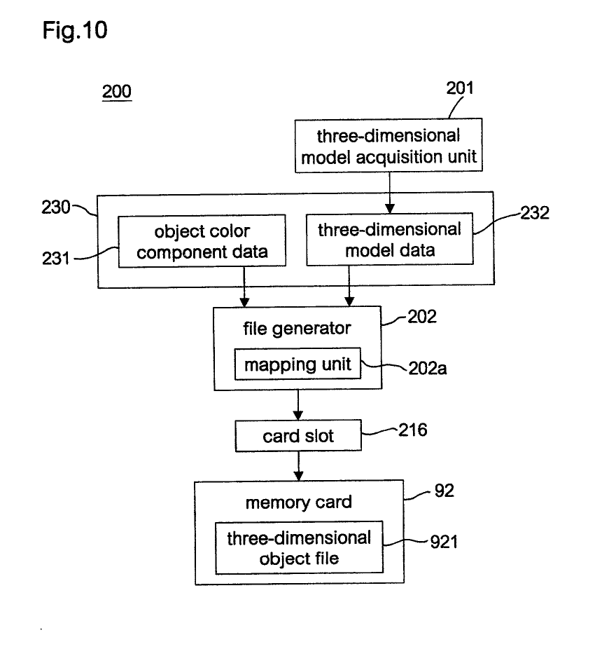

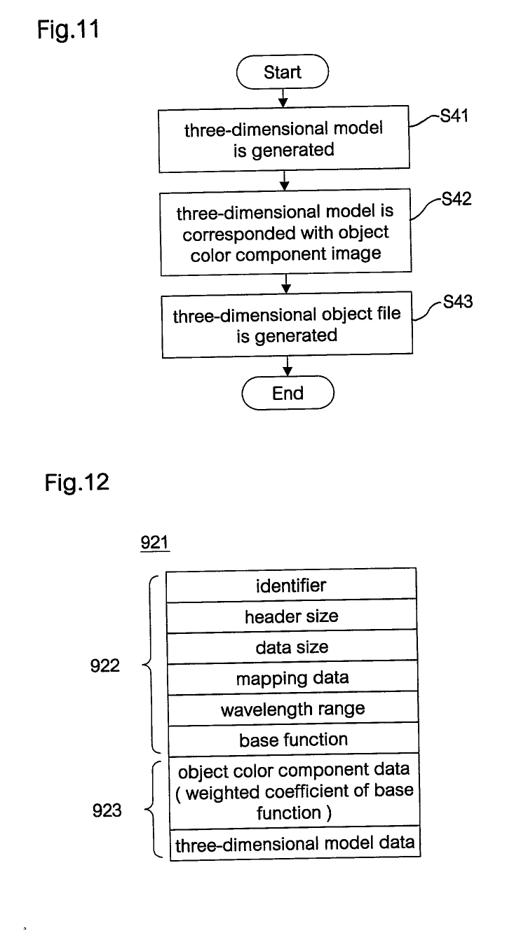

FIG. 10 is a block diagram showing the function structure realized by operating the CPU 211 in accordance with the program 211a after the object color component data 231 are saved in RAM 230 in the image capture device 200. In FIG. 10, the CPU 211 realizes the functions of the three-dimensional model acquisition unit 201 and the file generator 202. FIG. 11 shows the operation flow of the three-dimensional model acquisition unit 201 and the file generator 202.

Virtually simultaneously with the acquisition of the object color component data 231, the three-dimensional model acquisition unit 201 generates a three-dimensional model from the distance image acquired by the image sensing unit 240 and the scanning unit 250 (step S41). That is, data of a three-dimensional model (e.g., surface model) representing the shape of the object are generated from data representing the distance from the image capture device 200 to multiple points on the object, and are saved as three-dimensional model data 232 in the RAM 230.

When the three-dimensional model data 232 are acquired, the object color component data 231 and the three-dimensional model data 232 are input to a file generator 202. Then, a mapping unit 202a specifies the pixels of the object color component image corresponding to representative points (e.g., the apex of each surface comprising the three-dimensional model) on the surface of the three-dimensional model (step S42). The correspondence between a point on the three-dimensional model and a pixel of the object color component image can be readily determined from the positional relationship of the image sensing unit 240 and the scanning unit 250. Thereafter, the file generator 202 generates a three-dimensional object file 921 in the memory card 92 through the card slot 216, and the object color component data 231 and three-dimensional model data 232 are saved therein (step S43).

FIG. 12 shows the structure of the three-dimensional object file 921. The header 922 of the three-dimensional object file 921 stores an identifier indicating that it is a three-dimensional object file, header size, data size, mapping data representing the correspondence the object color component image and surface of the three-dimensional model, wavelength range when calculating object color component data, and base function Si(λ) of the object color component data. A data unit 923 stores object color component data (i.e., weighted coefficient σi of the base function), and three-dimensional model data.

In the image capture device 200, the spectral reflectance of the object and a color component image equivalent thereto, and a three-dimensional model representing the shape of the object are mutually associated and stored in a single file. In this way, transfer, copy, erasure and the like of the object color component data and three-dimensional model data can be integratedly accomplished, for ease of data handling.

Although a three-dimensional model and object color component image of an object are generated from a single direction in the above description, a plurality of distance images and plurality of object color component images of an object may be acquired from a plurality of directions as necessary, and by combining these images a three-dimensional model of virtually the complete object and object color component image corresponding to the surface of the three-dimensional model may be generated.

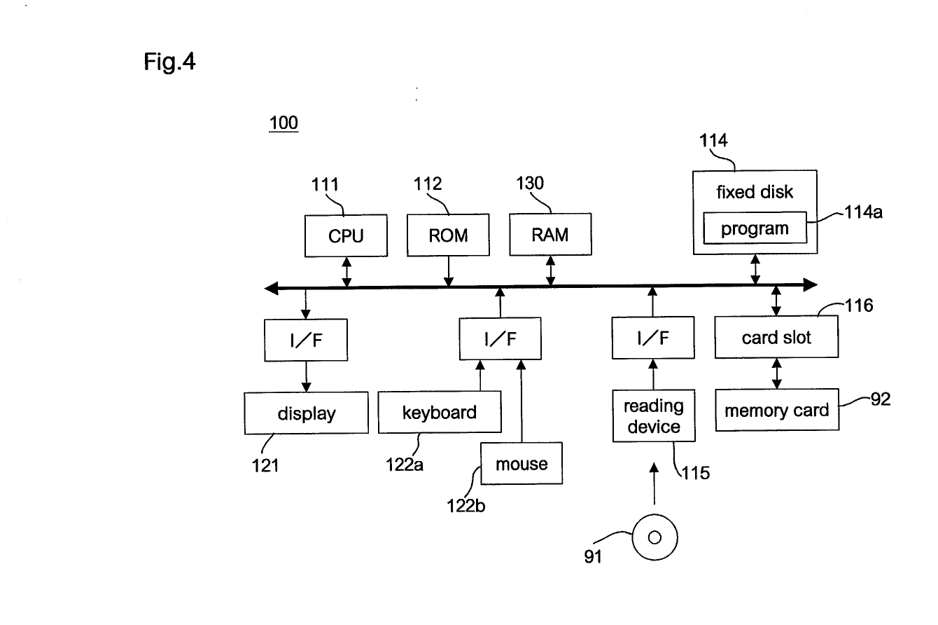

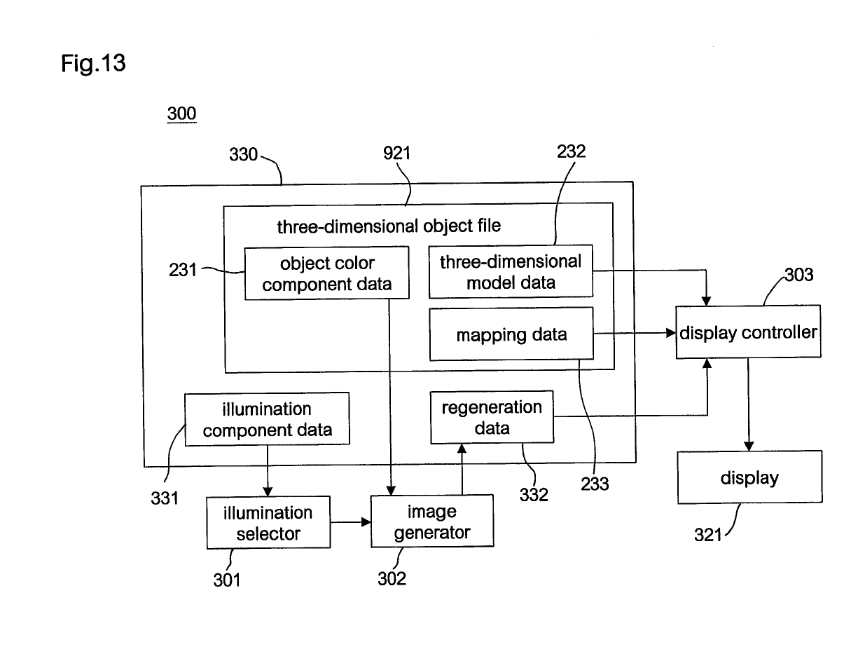

The regeneration of an image by an image regeneration device using the three-dimensional object file 921 is described below. FIG. 13 is a block diagram showing the function structure of an image regeneration device 300. The physical structure of the image regeneration device 300 is identical to a normal computer. The structure is shown in FIG. 4. That is, a program is installed in the image regeneration device 300 beforehand via a recording medium, and the program is executed by a CPU to operate the computer as the image regeneration device 300.

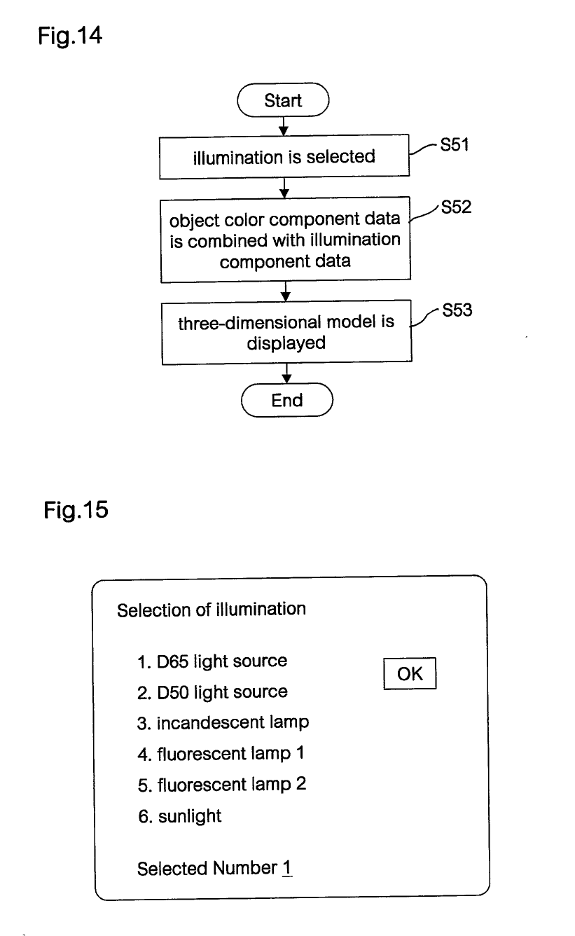

In FIG. 13, an illumination selector 301 represents the functions realized by a keyboard, mouse or the like, and an image regenerator 302 represents the functions realized by calculations performed by a CPU. A display controller 303 represents the functions of a COY and special graphics board. FIG. 14 shows the operation flow of the image regeneration device 300 when a three-dimensional model is regenerated using the three-dimensional object file 921.

Illumination component data 331 (i.e., weighted coefficient ei and base function Ei(λ) in equation 1) essentially equivalent to the spectral distributions of a plurality of types of illumination light prepared beforehand are provided within the RAM 330 of the image regeneration device 300. Then, the illumination selector 301 receives the illumination selection of an operator (step S51). FIG. 15 shows an example of the display content when illumination light is selected. As shown in FIG. 15, it is possible to select standard light D65 or D50, sunlight, fluorescent light and the like as the illumination light. The illumination light also may be created by the operator.

When illumination light is selected, the object color component data 231 and selected illumination component data are combined by the image regenerator 302 via the calculations of equations 3 and 4, so as to generate regeneration data 332 (step S52). That is, an image using the object color component image is regenerated.

Next, three-dimensional model data 232, mapping data 233, and regeneration data 332 are input to the display controller 303, and three-dimensional model having the regeneration image affixed to the surface of the three-dimensional model is generated in accordance with the mapping data 233, and the three-dimensional model reflecting the influence of the illumination light is displayed on the display 321 (step S53).

The calculations shown in equations 3 and 4 are premised on illumination by diffused light, however, it is possible to reflect the influence of illumination by a point light source, and parallel light on a three-dimensional model using well-known shading methods. For example, a color reflection model using a dichromatic reflection model is disclosed by Shoji Tominaga (“Color perception and color media process (V.) and computer perception of color and color image analysis” Denki Jouhou Tsushin Gakkai Shi, vol. 82, No. 1; pp.62-69, January, 1999). In this method, spectral radiation luminance Y (θ,λ) on an object (i.e., spectral intensity of light from an object impinging an observer) can be determined by the calculation of equation 6. Y(θ,λ)=_{CS}(θ)S_{S}(λ)E(λ)+_{CD}(θ)S_{D}(λ)E(λ) (Expression 6)

In equation 6, λ is the wavelength, θ is the geometric parameters such as incident angle, phase angle, observation angle and the like, Ss(λ) and SD(λ) are spectral reflectance s corresponding to mirror surface reflection and diffused reflection, respectively, Cs(O) and CD(θ) are weight coefficients of the geometric parameters, and E(λ) represents the spectral distribution of the illumination light.

Since the object color component data 321 does not include spectral reflectance Ss(λ) corresponding to mirror surface reflection, Ss(λ) is fixed at [1] during calculation, and the coefficients Cs(θ) and CD(θ) can be suitably determined. In this way, a three-dimensional model can be generated in consideration of the direction of illumination light. Furthermore, when this method is used, the three-dimensional model data 232 and mapping data 233 are input to the image regenerator 302.

As described above, three-dimensional models reflecting the influence of various illumination environments can be suitably regenerated by using the three-dimensional object file 921 in the image regeneration device 300.

Specifically, in the field of virtual reality, various projection images can be realized in real time based on on-the-spot picture images by generating a three-dimensional model reflecting the influence of various illumination lights. For example, a real-time three-dimensional projection image can be developed in a projection dome where a three-dimensional image can be enjoyed using a head-mounted display, or polarized glasses.

Although object color component data 231 are generated by the image capture device 200, and a three-dimensional model is displayed by the image regeneration device 300 in the above description, the generation of the object color component data 231 and the mapping process also may be performed by the image regeneration device 300. In this case, the existing image capture device for acquiring a distance image and a two-dimensional image may be used directly as the image capture device 200. Furthermore, the distance image need not be acquired using a so-called rangefinder, e.g., the distance image may be acquired by binocular vision. When binocular vision is used, a distance image can be acquired by positioning a normal digital camera at two positions.

<Second Embodiment>

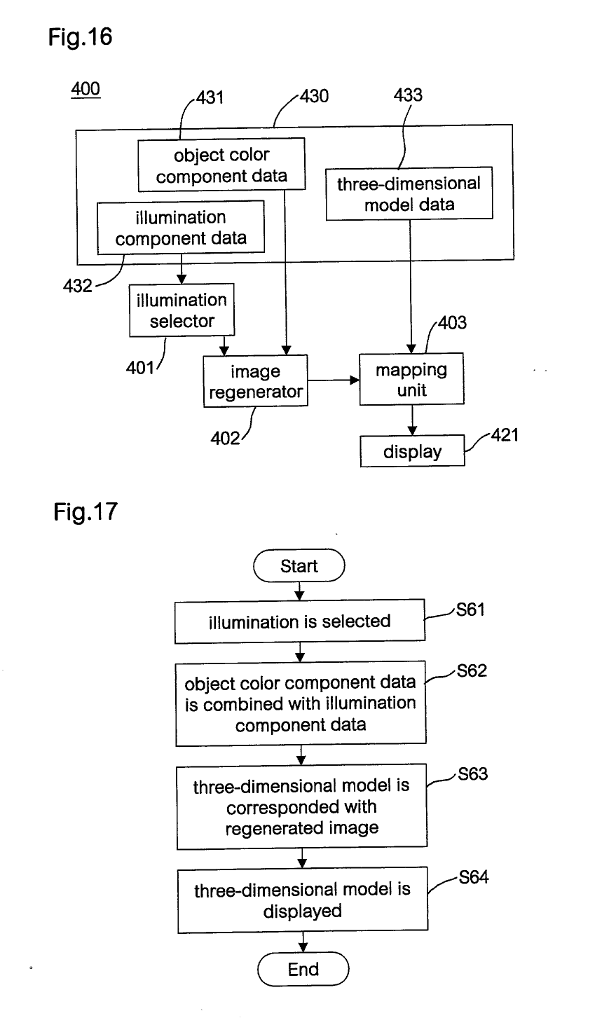

Although an object color component image and three-dimensional model are acquired from the same object in the first embodiment, the object color component image and the three-dimensional model also may be acquired separately (i.e., as separate files). FIG. 16 shows the function structure of an image regeneration device 400 for regenerating a three-dimensional model from object color component data 431 and three-dimensional model 433 acquired separately.

The physical structure of the image regeneration device 400 is similar to a normal computer, and its structure is shown in FIG. 4. That is, a program is installed in the image regeneration device 400 beforehand through a recording medium, and the computer operates as the image regeneration device 400 when the CPU executes the program.

In FIG. 16, an illumination selector 401 and mapping unit 403 represent the functions realized by a CPU, keyboard, mouse and the like, and an image regenerator 402 represents the functions realized by the calculation processing performed by the CPU.

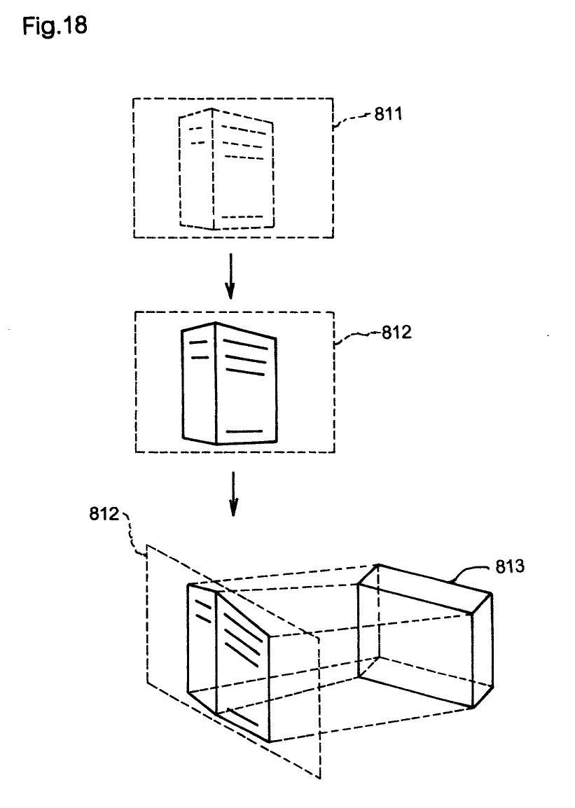

FIG. 17 shows the operation flow of the image regeneration device 400 when regenerating a three-dimensional model, and FIG. 18 shows an example of the condition of regenerating a three-dimensional model. Similar to the first embodiment, illumination component data 432 essentially equivalent to the spectral distribution of illumination light of a plurality of types are stored beforehand in RAM 430 of the image regeneration device 400, and the illumination light selected by the operator is received by the illumination selector 401 (step S61).

When illumination light is selected, the object color component data 433 (refer to reference number 811 in FIG. 18) and the selected illumination component data are combined in the image regenerator 402 by calculation of equations 3 and 4, to generate data of a two-dimensional regeneration image (refer to reference number 812) (step S62). That is, regeneration of the image is accomplished using the object color component image.

Next, the data of the two-dimensional regenerated image and the three-dimensional model 433 are input to the mapping unit 403. The operator maps the two-dimensional regenerated image to the surface of the three-dimensional model using the mouse while referencing the two-dimensional regenerated image and the three-dimensional model (refer to reference number 813) displayed on a display 421 (step S63). In this way, a three-dimensional model having the regenerated image pasted to the surface of the three-dimensional model is generated, and the three-dimensional model reflecting the influence of the illumination light is displayed on the display 421 (step S64). At this time, it is possible to reflect the influence of illumination by a point light source, and parallel light on a three-dimensional model using well-known shading methods.

As described above, in the image regeneration device 400, a two-dimensional image is generated in which the influence of illumination light is apparent in the object color component image, an a three-dimensional model is generated in which the two-dimensional image is pasted on the surface of a three-dimensional model. In this way, it is possible to suitably generate a three-dimensional model in which a sense of incompatibility reflecting the influence of various illumination environments is absent. That is, a high-quality three-dimensional model is generated by applying an object color component image as a computer graphic image to the art of image base rendering (i.e., pasting an on-the-spot picture image (two-dimensional image) on a three-dimensional model).

Image base rendering using an object color component image can be used in the field of virtual reality similar to the first embodiment, and various real-time projection images can be realized based on on-the-spot picture images.

<Third Embodiment>

FIG. 4 is a block diagram showing the structure of an image processing device 100 of a third embodiment. In the image processing device 100, computer graphics lacking the aforesaid sense of incompatibility are easily realized by using object color component data.

The image processing device 100 has a structure similar to a normal computer; a bus line connects a CPU 111 for executing various calculation processes, a ROM 112 for storing basic programs, and a RAM 130 for storing various types of information. A fixed disk 114 for storing information, a display 121 for displaying various information, keyboard 122a and mouse 122b for receiving input from an operator, a reading device 115 for reading data and programs from a recording medium 91 such as an optical disk, magnetic disk, magneto-optical disk and the like, and a card slot 116 for transferring data between the device and a memory card 92 are connected to the bus line via suitable interfaces (I/F).

A program 114a is read from the recording medium 91 through the reading device 115 beforehand and stored on the fixed disk 114 in the image processing device 100. Then, the operation described below is accomplished by copying this program to RAM 130, and the CPU 111 executing calculation processes in accordance with the program in RAM 130.

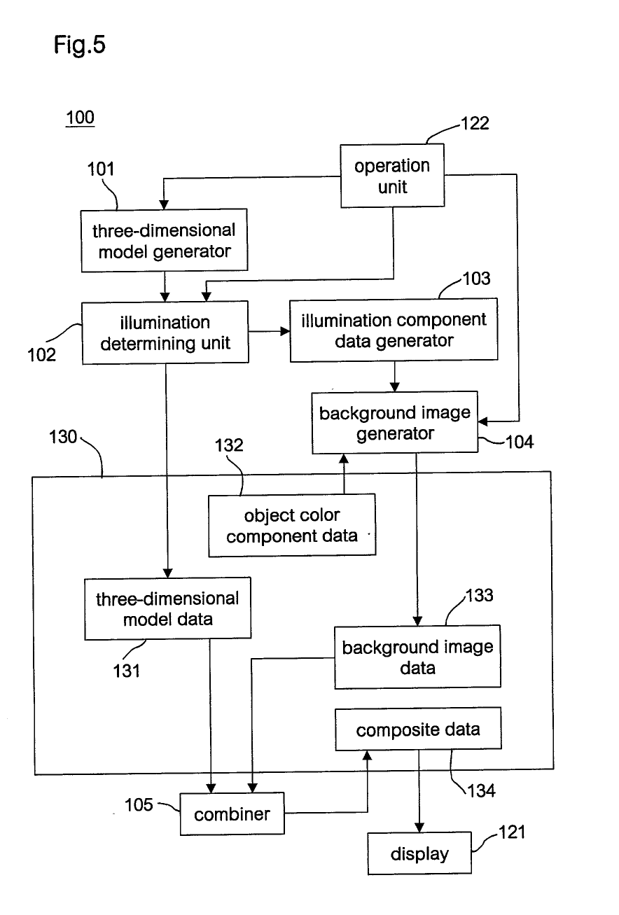

FIG. 5 is a block diagram showing the function structure realized by the operation of CPU 11 in accordance with the program 114a. In FIG. 5, the functions of a three-dimensional model generator 101, illumination determining unit 102, illumination component data generator 103, background image generator 104, and combiner 105 are realized by the CPU 111. The operation unit 122 is equivalent to the keyboard 122a and mouse 122b of FIG. 4.

Object color component data 132 are stored beforehand in the RAM 130. The object color component data 132 may be generated in the image processing device 100 after first and second image data 31 and 32 captured by a digital camera have been acquired through a memory card 92 and card slot 116 (refer to FIG. 1), or may be the object color component data 132 may be generated by a digital camera or computer beforehand, and transferred to the RAM 130.

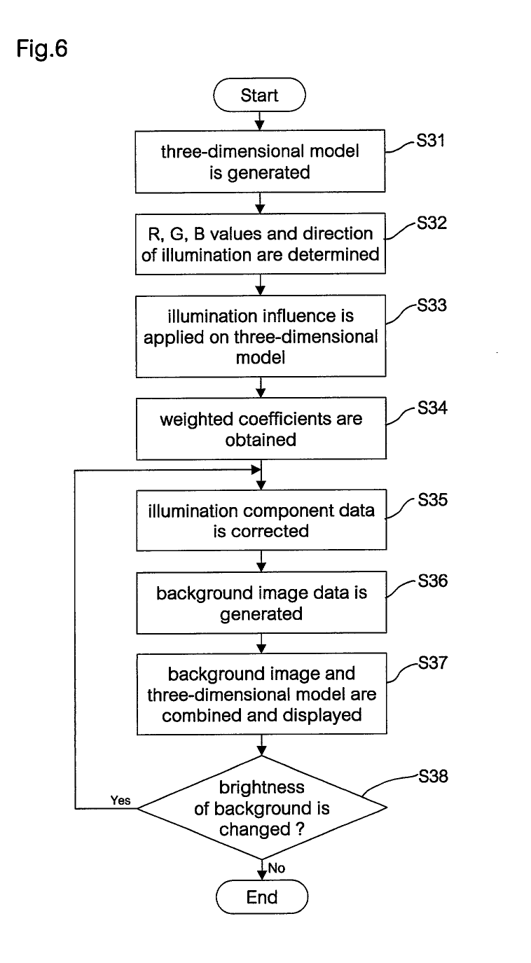

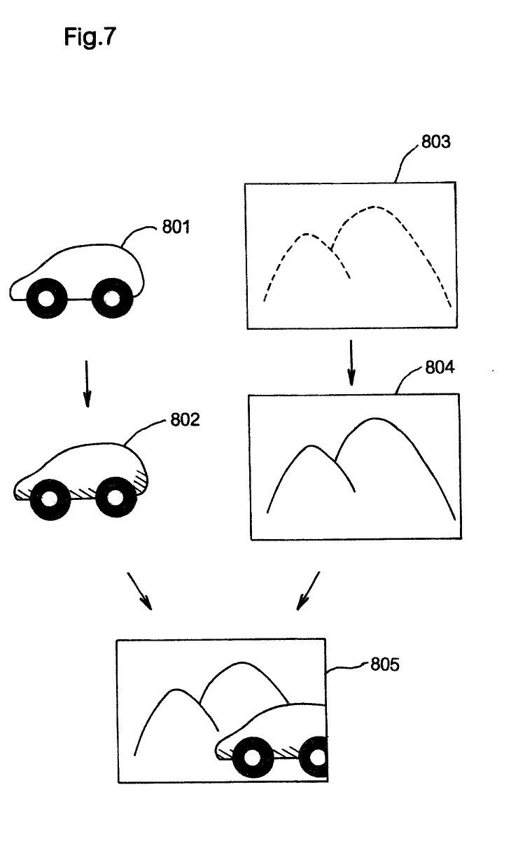

FIG. 6 shows the operation flow of the image processing device 100, and FIG. 7 shows the condition of processing by the image processing device 100. The operation of the image processing device 100 is described below with reference to FIGS. 5˜7. First, a three-dimensional model generator 101 generates a three-dimensional model in accordance with input from an operator received via the operation unit 122. Then, color is affixed to the three-dimensional model (step S31; refer to reference number 801 in FIG. 7). In an illumination determining unit 102, the radiation direction of the illumination light and the color of the illumination light participating in the three-dimensional model are determined in accordance with operator input received via the operation unit 122. The color of the illumination light is determined using R, G, B values, and the direction of the illumination light is determined by the position of the light source and direction vectors (step S32).

When the illumination light is determined, a process of effecting the influence of the illumination environment on the three-dimensional model is implemented, i.e., coloring change and shading are implemented (step S33; refer to reference number 802 in FIG. 7). The corrected data of the three-dimensional model are saved as three-dimensional model data 131 in the RAM 130.

On the other hand, the R, G, B values of the determined illumination light are input to the illumination component data generator 103, and converted from the R, G, B values to the spectral distribution of the illumination light. The spectral distribution of the illumination light is determined by the format shown in equation 1. The CIE daylight base function and fluorescent light base function are determined beforehand as base function Ei(λ), and the weighted coefficients εi corresponding to the base function are set as the illumination component data. (step S34).

The illumination component data are transferred to the background image generator 104, and the coefficient to be multiplied by the weighted coefficient εi is input to the background image generator 104 through the operation unit 122. The background image generator 104 corrects the illumination component data by multiplying the input coefficient by each weighted coefficient εi (step S35). In this way, the intensity of the illumination light is adjusted while maintaining uniformity of the relative spectral distribution of the illumination light represented by the illumination component data.

Thereafter, the object color component data 132 and the corrected illumination component data are combined by the calculations shown in equations 3 and 4, to generate image data (hereinafter referred to as “background image data”) 133 for use as background (step S36). That is, a displayable background image (refer to reference number 804) is generated by combining data derived from the background environment participating in the three-dimensional model with the object color component image (refer to reference number 803 in FIG. 7).

The three-dimensional model data 131 and the background image data 133 are input to the combining unit 105, and composite data 134 are generated by combining these image data. A composite image of the combined background image and the three-dimensional model based on the composite data 134 is displayed on the display 121 (step S37; refer to reference number 805 in FIG. 7).

When it is determined that the background is too bright or too dark relative to the three-dimensional model when the operator views the composite image (step S38), the coefficient multiplied by the weighted coefficient εi is changed and the steps S35˜S37 are repeated. In this way, the intensity of the illumination light is changed while maintaining uniformity of the relative spectral distribution in the background image. When the brightness of the background is suitable to the three-dimensional model, the image generation process ends in the image processing device 100.

As described above, a background image is generated from a color component image using the spectral distribution of the illumination light when generating a three-dimensional model in the image processing device 100. Accordingly, since only the intensity of the illumination light is changed when generating the background image, the ambience of the three-dimensional model and the background image can be suitably matched. That is, a composite image is easily generated without a sense of incompatibility between the three-dimensional model and the background image.

Normally, the intensity of the illumination light relative to the background is set weaker than the illumination light relative to the three-dimensional model, however, the intensity of the illumination light may be increased when the background is bright. Furthermore, the spectral characteristics of the illumination light combined with the object color composite image may be adjustable. In this case, since in general the background image initially generated is a suitable image, the spectral characteristics of the illumination light may be used with little adjustment.

In the above description, illumination light is determined virtually using the R, G, B values, however, the spectral distribution of the illumination light also may be directly determined, or the spectral distribution may be read from an external source. The background image need not be the entire background, and may be combined in various forms with the three-dimensional model as part of the ultimately generated image.

<Modifications>

Although the present invention has been described in the embodiments, the present invention is not limited to these embodiments and may be variously modified. In the above embodiments, a method using two images acquired by turning the flash ON and OFF are described as a means for acquiring an object color component image, however, various other methods may be used as methods for acquiring an object color component image.

For example, a digital camera may be provided with a multiband sensor to acquire illumination light and its spectral distribution, i.e., to acquire illumination component data, and the object color component data may be may be determined from the image data and illumination component data. A metallic film interference filter having different step-like thicknesses provided on a CCD is known as a compact, high-resolution multiband sensor, such as disclosed by Nobokazu Kawagoe et al. in “Spectrocolorimeter CM-100,” Minolta Techno Report No. 5, 1988 (pp. 97˜105). In this multiband sensor, the thickness of a metallic film interference filter changes in each area of the CCD, and the intensity of light of a specific wavelength band can be obtained in each area of a CCD.

Furthermore, a plurality of images may be acquired by sequentially positioning a plurality of color filters in front of a monochrome CCD, and determining object color component data from these images. For example, such a usable method is disclosed by Shoji Tominaga in “Algorithms and camera systems realizing color constancy,” Technical Paper of the Institute of Electronics and Communication Engineers of Japan, PRU 95-11 (1995-05; pp. 77˜84).

Modifications of the aforesaid methods include acquiring a plurality of images by exchanging at least a single filter so to be present or not in front of a color CCD, and determining object color component data therefrom. Illumination component data also may be of various kinds insofar as the data represent the influence of the illumination environment on an image, and insofar as the data represent the degree of influence of the illumination environment. Object color component data also may be of various types insofar as the data represent components excluding the influence of the illumination environment, and it is not necessary that the data represent components strictly excluding the influence of the illumination environment.

Although object color component data and illumination component data are acquired as a plurality of weighted coefficients (and base functions) in the above embodiments, these data also may take other forms. For example, the object color component data may be saved as a characteristics curve of spectral reflectance, and illumination component data may be saved as a characteristics curve of spectral distribution. Furthermore, the third embodiment may be combined with the first and second embodiments. In this case, the background image the three-dimensional model may be naturally combined.

According to the above embodiments, a composite image is easily obtained without a sense of incompatibility between the two-dimensional image and three-dimensional model. Furthermore, it is possible to suitably regenerate a three-dimensional model reflecting the influence of various illumination environments. The data of the object color component image and the data of the three-dimensional model may be handled integratedly.

Although the present invention has been fully described by way of examples with reference to the accompanying drawings, it is to be noted that various changes and modifications will be apparent to those skilled in the art. Therefore, unless otherwise such changes and modifications depart from the scope of the present invention, they should be construed as being included therein.

What is claimed is:

1. An image processing device comprising
an first acquisition unit for acquiring three-dimensional model data;
an second acquisition unit for acquiring object color component image data corresponding to an object color component image obtained by removing illumination environment influences from a two-dimensional image; and
a combining unit for combining the three-dimensional model data and the object color component image data so as to paste the object color component image on a surface of an image represented by the three-dimensional model data.

2. An image processing device as claimed in claim 1, wherein the combined three-dimensional model data and object color component image data are stored as one file.

3. An image processing device as claimed in claim 1, further comprising:
a receiving unit for receiving illumination color component data corresponding to illumination light onto an object; and
an applicator for applying the received illumination color component data to the object color component image which is pasted on the surface of the image represented by the three-dimensional model data.

4. An image processing device comprising:
a first acquisition unit for acquiring three-dimensional model data;
a second acquisition unit for acquiring two-dimensional image data;
a calculating unit for calculating object color component image data corresponding to an object color component image from which illumination environment influences are removed in a two-dimensional image based on the acquired two-dimensional image data; and
a combining unit for combining the three-dimensional model data and the object color component image data so as to paste the object color component image on a surface of an image represented by the three-dimensional model data.

5. An image processing device as claimed in claim 4, wherein the combined three-dimensional model data and object color component image data are stored as one file.

6. An image processing device as claimed in claim 4, further comprising:
a receiving unit for receiving illumination color component data corresponding to illumination light onto an object; and
an applicator for applying the received illumination color component data to the object color component image which is pasted on the surface of the image represented by the three-dimensional model data.

7. An image processing method comprising the steps of:
acquiring three-dimensional model data;
acquiring two-dimensional image data;
calculating object color component image data corresponding to an object color component image from which illumination environment influences are removed in a two-dimensional image based on the acquired two-dimensional image data; and
combining the three-dimensional model data and the object color component image data so as to paste the object color component image on a surface of an image represented by the three-dimensional model data.

8. A computer program which makes a computer execute the steps of:
acquiring three-dimensional model data;
acquiring two-dimensional image data;
calculating object color component image data corresponding to an object color component image from which illumination environment influences are removed in a two-dimensional image based on the acquired two-dimensional image data; and
combining the three-dimensional model data and the object color component image data so as to paste the object color component image on a surface of an image represented by the three-dimensional model data.
